(19) United States
(12) Patent Application Publication
(10) Pub. No.: US 2026/0366551 A1
(43) Pub. Date: Nov. 19, 2026

(54) SET OF STRUCTURAL CONNECTING PARTS FOR ASSEMBLING ARCHITECTURAL/STRUCTURAL EDUCATIONAL MODELS

(71) Applicants: Marcio SEQUEIRA DE OLIVEIRA, São Paulo - SP (BR); MOLA EDUCATION LTDA EPP, São Paulo - SP (BR)

(72) Inventor: Marcio SEQUEIRA DE OLIVEIRA, São Paulo - SP (BR)

(21) Appl. No.: 19/635,897

(22) Filed: Apr. 1, 2026

(30) Foreign Application Priority Data
Apr. 1, 2025 (BR) BR102025006491-0

(51) Int. Cl. F16B 7/04; F16B 7/18; G09B 25/04

(52) U.S. Cl. CPC F16B 7/044; F16B 7/185; G09B 25/04

(57) ABSTRACT

A set of structural connection parts for assembling architectural and structural educational models as a teaching tool for structures, with an adjustable connection part with fixed positioning of springs at a fixed angle relative to each other, a connecting piece with flat surfaces such as paper, cardboard, transparencies, acrylic, EVA sheets, rubber, or any other material; a base clip piece between two or more metal plates; and a curved spring; all parts comprising distinct structural configurations of architectural and structural educational models.

### FIELD OF THE INVENTION

This invention relates to a set of structural connecting parts for the assembly of architectural/structural educational models, said set of structural connecting parts comprising: (i) an adjustable connecting part for the fixed positioning of springs at a fixed angle relative to one another; (ii) a connecting piece for flat surfaces such as paper, cardboard, transparencies, acrylic, EVA sheets, rubber, or any other material; (iii) a base clip piece for quick and easy connection between two or more metal plates, creating larger floor surfaces for assembling larger structures; (iv) a curved spring used in conjunction with the other model parts, respecting the modularity of the assembled structures.

These innovative connecting parts expand the possibilities for assembling different elements and enhance the creation of numerous structural configurations for architectural/structural educational models with new effects, thereby enabling the execution of practical activities and the understanding of these concepts.

### BACKGROUND OF THE INVENTION

It is a fact that the use of architectural/structural models in the classroom presents itself as a promising alternative to overcome the limitations of traditional structural teaching methodology. By providing a more concrete and visual learning experience, architectural/structural models can contribute to a better understanding of concepts, greater student engagement, and, consequently, to the training of more qualified professionals.

The construction of architectural/structural models can be a valuably teaching resource, but their use must be balanced with other tools and methodologies. The complexity and cost of producing detailed architectural/structural models may limit their large-scale application.

In addition to the points mentioned, it is important to consider other limitations of physical architectural/structural models, such as the difficulty of representing complex structures and the possibility of construction errors that can lead to misinterpretations.

Similarly, the limited course hours for these structural engineering courses prevent the implementation of more elaborate practical activities, such as the construction of diverse structural configurations, thereby limiting students'ability to visualize and experiment with structural phenomena.

Accordingly, the applicant, who is active in the development of components for the modular construction of architectural/structural models that simulate the behavior of real structures, is the owner and applicant of several patents, including BR 20.2015.032931-3, BR 20.2016.00751-2, BR 11.2018.00958-0, and BR 10.2021.00273-6; the latter, in turn, pertains to a kit of structural parts for the construction of educational architectural and structural models; said kit includes an instruction manual, plates, and other structural parts that facilitate the learning of concepts taught in class through the visual and tactile experience of structural deformation behavior; said structural parts comprise: i) metal cables formed by multiple spherical and hollow elements connected to one another by rods equipped with limiters; ii) cable clip elements equipped with openings capable of receiving the spherical elements of the metal cables; iii) cable connection elements comprising two parts capable of moving linearly to extend the cable or retract it for cable tension adjustment; iv) stiffeners for deformable bars to form rigid elements (ER); v) cable cutter; and vi) multi-cable clip for simultaneously receiving more than one metal cable.

All of the aforementioned documents from the same applicant present parts for the construction of architectural and structural educational models that can be used in conjunction with the structural connection parts of the application in question, thereby expanding the possibilities for assembling architectural/structural educational models.

### ANALYSIS OF THE STATE OF THE ART

In a search conducted in specialized databases, documents were found relating to a set of structural connection parts for the composition of architectural/structural educational models, such as document no. PI 0303779-7, which deals with an educational model comprising a wooden base on which plates are placed to demonstrate the built site, consisting of parts of different shapes. Plates demonstrating the natural site are placed on top of the plates of the built site; these are also composed of multiple parts, similar to the parts located on the lower section, comprising the built site.

Document No. US2010318974 refers to elements that simulate a structure and provide a stable testing environment. Test data is provided within the structurally simulated environment to ensure the consistency and accuracy of tests.

Document No. CN104821119 comprises magnetic connectors and connecting rods whose ends are attached to the magnetic connectors. The multiple magnetic connectors and connecting rods are magnetically connected to one another in a three-dimensional geometric configuration, and the multiple magnetic connectors include at least one laser connector equipped with a laser emitter. According to the invention, the magnetic connectors are used as vertices of a three-dimensional geometric wireframe model, the connecting rods whose ends are attached to the magnetic connectors are used as edges of the three-dimensional geometric wireframe model, the magnetic connectors and connecting rods constitute the three-dimensional geometric wireframe model as an educational demonstration model, and the edge relationships of the three-dimensional geometric shape can be clearly displayed. The magnetic connectors and the connecting rods are magnetically connected, so that the positions of the magnetic connectors and the connecting rods can be changed according to a geometric shape to be demonstrated, and different geometric shapes can be demonstrated.

Although the cited documents belong to the same field of application, their characteristics differ significantly from those presented by the present invention. The innovations proposed herein ensure that the solution presented here meets the legal requirements of novelty and inventive step.

### OBJECTIVES OF THE INVENTION

The objective of the invention is to present a set of structural connection parts for assembling architectural/structural educational models, comprising a flat-surface connection part, an adjustable connection part, base connection parts, and curved springs, which expand the possibilities for assembling different elements and enhance the creation of numerous structural configurations of architectural/structural educational models.

The objective of the invention is to provide a set of structural parts whose flat-surface connector allows for the attachment of new materials and components to the educational model assembly system, such as any flat surfaces up to 1.5 mm thick, for example, different types of paper, cardboard, transparencies, acrylic, EVA foam sheets, rubber, or any other material. In addition to flat surfaces, this flat-surface connection piece allows for the connection of other components, such as custom parts printed in 3D or modeled using any other process, provided they have a flat section no more than 1.5 mm thick. The connection of surfaces via this innovative connection piece enables a high degree of customization of the structures assembled by users.

The objective of the invention is to present a set of structural parts in which the flat-surface connector features a central slot with a built-in spring that allows for the preliminary securing of the surfaces to adjust their position, followed by tightening the screw to ensure the permanent fixation of the element. This feature facilitates the process of assembling structures with the surfaces.

The objective of the invention is to provide a set of structural parts wherein the flat-surface connection piece has the same outer diameter as the springs used in the architectural/structural models of the same applicant, allowing the other connecting parts to be joined via magnets, since said flat-surface connection piece provides for a carbon steel plate coating that surrounds the outer face of the cylinder. The entire interior of the piece is made of plastic.

The objective of the invention is to provide a set of structural parts whose adjustable connecting piece allows for a fixed positioning of the springs relative to the system's connection (steel ball), ensuring that the springs maintain a fixed angle between them. This piece enables the assembly of arch structures composed of straight bars (springs).

The objective of the invention is to provide a set of structural parts whose adjustable connecting piece consists of two hemispherical parts fixed together by a central screw, each hemispherical part having a plastic end equipped with an insert and a screw to allow for the fastening of the system's springs/bars, and the tightening of the central screw defining the positioning of the hemispherical parts and, consequently, of the springs.

The objective of the invention is to present a set of structural parts in which the adjustable connecting piece has the same outer diameter as the system's connecting spheres previously presented by the applicant for the construction of educational architectural/structural models, allowing other parts to be connected and ensuring the system's modularity. To enable the connection of these other parts via magnets, the adjustable connecting piece is fitted with carbon steel sheet covers that wrap around the outer surface of the hemisphere, while the entire inner part of the piece is made of plastic.

The objective of the invention is to provide a set of structural components whose base clip allows for quick and easy connection between two or more metal base plates. This component enables users to join more than one base plate, creating larger floor surfaces for assembling larger structures.

The objective of the invention is to provide a set of structural components, wherein the base clip—comprising a plastic part housing a pair of magnets and featuring a non-slip silicone pad on its underside—ensures the stability and proper positioning of the plates during the assembly and analysis of the structures.

The objective of the invention is to present a set of structural parts, including a curved spring composed of two straight sections at the ends with embedded magnets, wherein said straight sections allow other parts of the educational model by the same applicant to be connected to this part. These curved springs may have various shapes, with the length and shape of the curved section varying depending on the assembly requirements.

### BRIEF DESCRIPTION OF THE DRAWINGS

To supplement this description in order to provide a better understanding of the characteristics of the present invention and in accordance with a preferred practical embodiment thereof, a set of drawings is attached to the description, in which, by way of example, though not limited thereto, its operation is illustrated:

FIG. 1 shows a perspective view of the parts that make up the set of structural connection parts for assembling the architectural/structural educational models in question;

FIG. 2A shows a perspective view of an educational model illustrating the use of the adjustable connecting piece for the fixed positioning of the springs;

FIG. 2B shows an enlarged perspective view of the adjustable connection piece;

FIG. 2C illustrates an exploded top perspective view of the parts comprising the adjustable connecting piece;

FIG. 2D illustrates an exploded bottom perspective view of the parts comprising the adjustable connecting piece;

FIG. 2E shows another exploded perspective view of the parts comprising the adjustable connecting piece;

FIG. 2F illustrates an assembled perspective view of the adjustable connecting piece;

FIG. 2G shows a front view;

FIG. 2H shows a top view;

FIG. 2I shows a side view;

FIGS. 2J and 2L show longitudinal section views A.A. indicated in FIG. 2H, illustrating the movement of the parts for the angular positioning of the springs;

FIGS. 2M, 2N, and 2O show top views of the adjustable connecting piece, illustrating the angular positioning of the springs;

FIG. 3A shows a perspective view of a teaching model illustrating the use of the flat-surface connector;

FIG. 3B shows an enlarged perspective view of the flat-surface connector;

FIG. 3C shows an exploded perspective view of the parts comprising the flat-surface connector;

FIG. 3D illustrates a rear perspective view of the flat surface connector;

FIG. 3E shows a top view;

FIG. 3F shows a front view;

FIG. 3G shows a side view;

FIG. 3H ilustrastes a partial sectional perspective view;

FIG. 3I shows a longitudinal section B. B indicated in FIG. 3F;

FIG. 3J shows the same longitudinal section B. B illustrating the use of a thicker panel;

FIG. 4A shows a perspective view of an educational model base illustrating the use of the base clip;

FIG. 4B shows an enlarged perspective view of the base clip par ;

FIG. 4C illustrates an exploded perspective view of the parts that make up the base clip;

FIG. 4D shows a bottom perspective view;

FIG. 4E shows a cross-sectional view C.C. indicated in FIG. 4D;

FIG. 5A depicts the curved spring used in conjunction with the other parts of the model, respecting the modulation of the assembled structures; and

FIG. 5B shows a variation of the curved spring.

### DETAILED DESCRIPTION OF THE INVENTION

The present patent relates to a set of structural connecting parts for the construction of architectural and structural education models having a set of structural connection parts (100) for assembling architectural/structural educational models (MQ) as a teaching tool for structures.

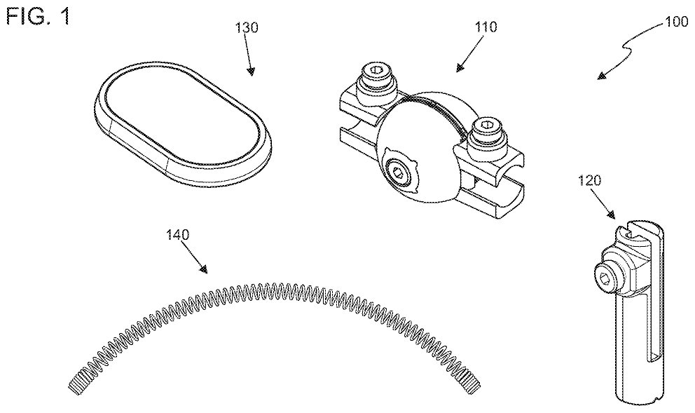

According to the present invention, said set of structural connecting parts (100) (see FIG. 1) for forming architectural/structural educational models (MQ) comprises an adjustable connecting part (110) with springs (ML) fixed at a fixed angle (α) relative to one another, a connecting piece (120) with flat surfaces (SP) such as paper, cardboard, transparencies, acrylic, EVA sheets, rubber, or any other material; a base clip piece (130) between two or more metal plates (PL); and a curved spring (140). These parts (110), (120), (130), and (140) comprise distinct structural configurations of architectural/structural educational models (MQ).

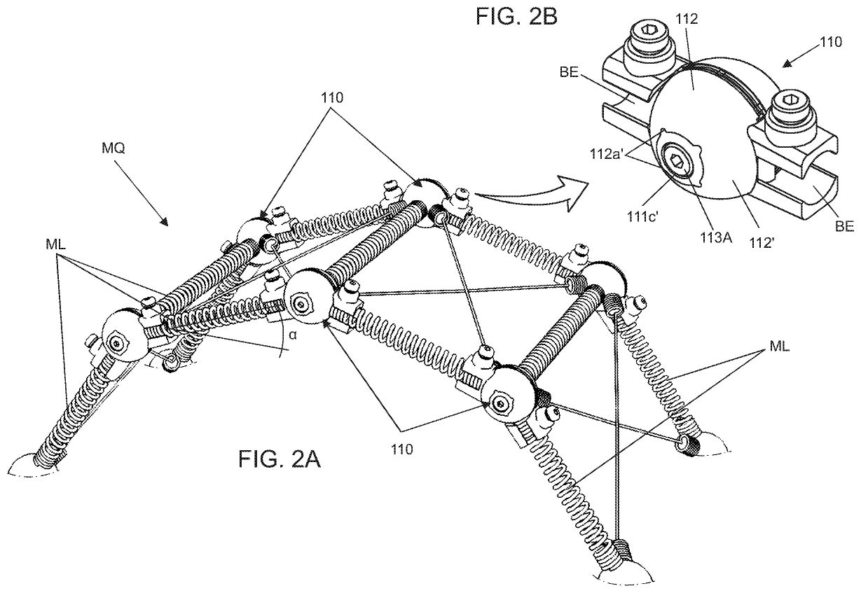

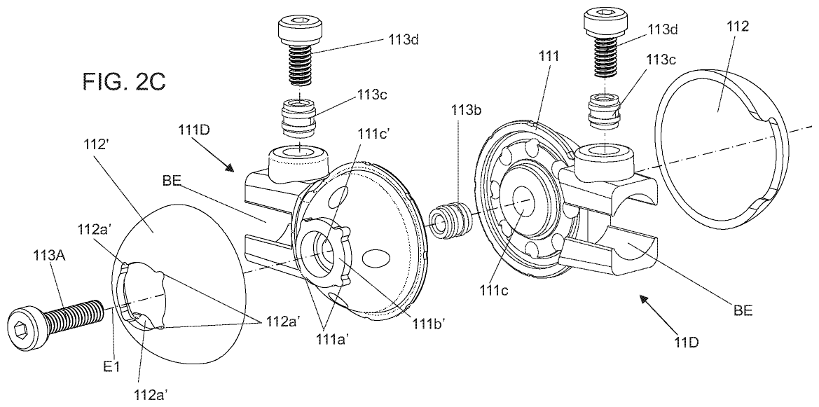

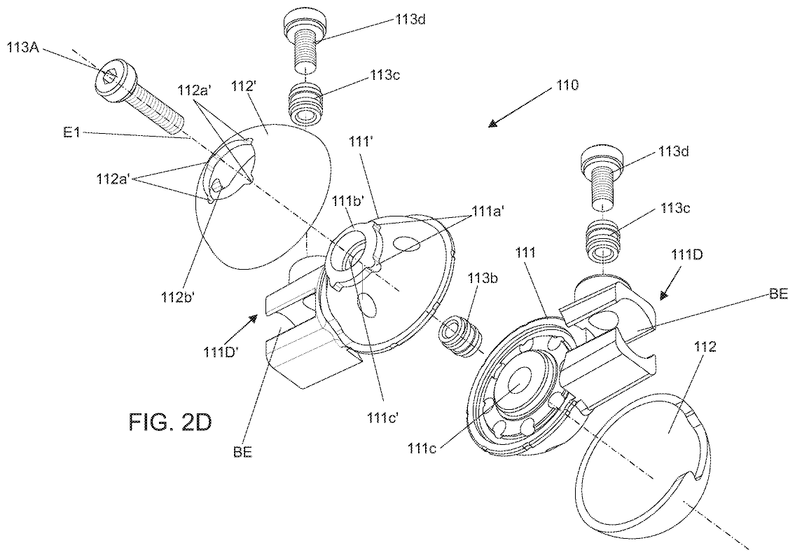

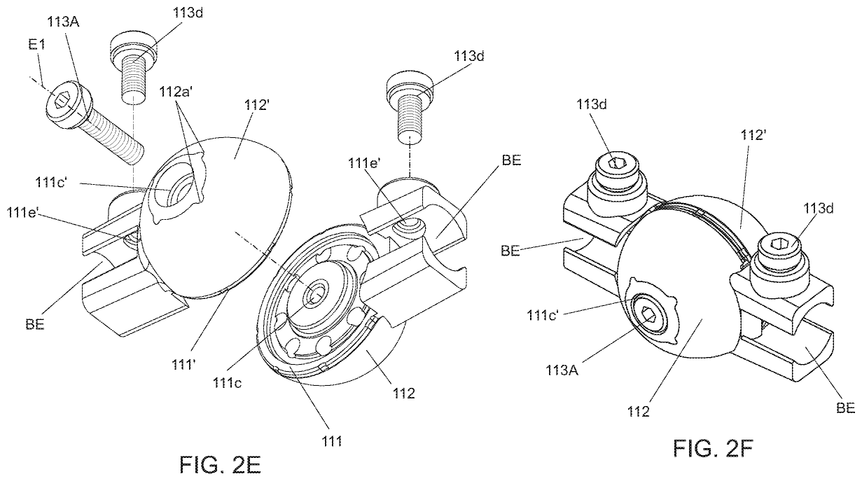

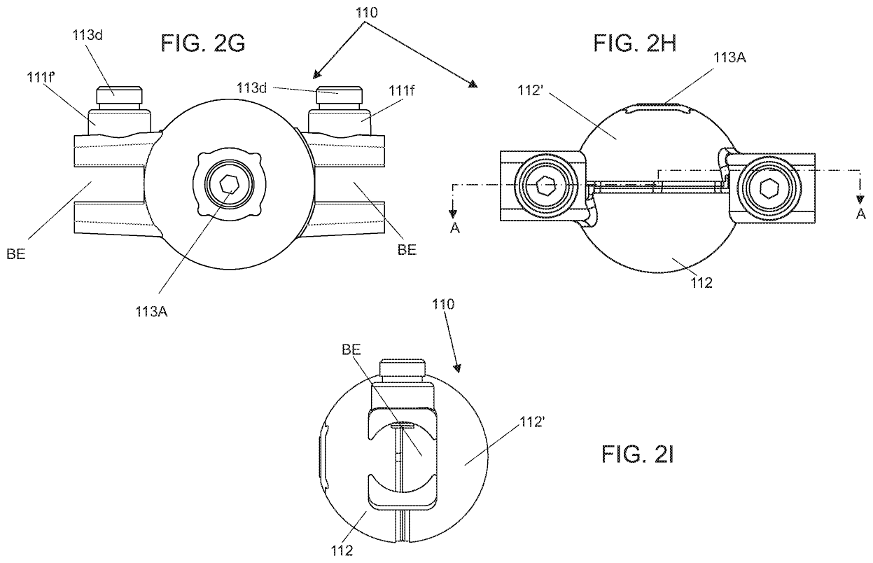

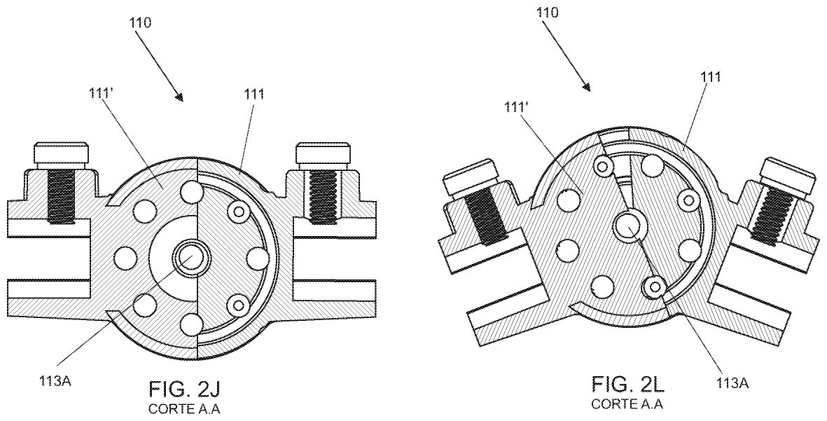

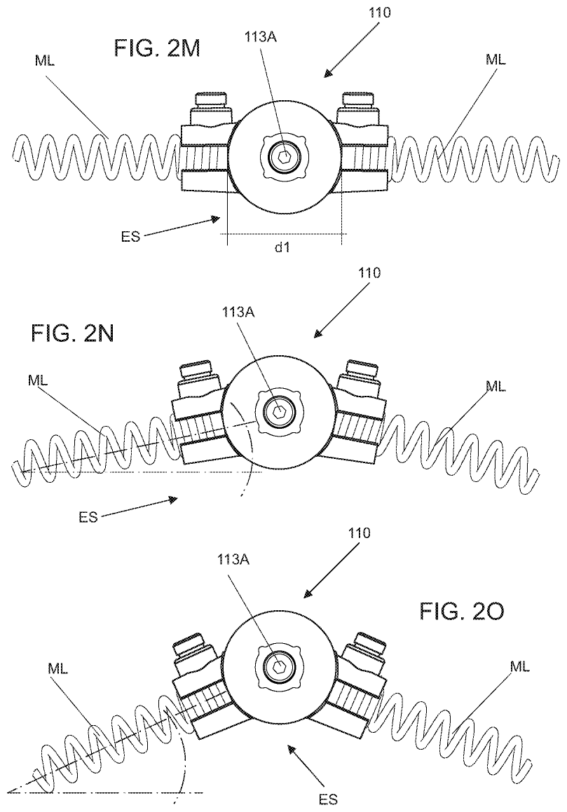

This adjustable connecting piece (110) (see FIGS. 2A through 2O) consists of two identical, matching hemispherical parts (111)/(111′) (see FIGS. 2C, 2D, and 2E) that are identical, corresponding, and made of polymer, which are provided with holes and recesses for material relief, as well as covered by caps (112)/(112′) made of carbon steel sheet, said cap (112′) being provided with a central hole (112b′) where radial recesses (112a′) are formed at the edge and engage with radial teeth (111a′) provided at the edge of the central flange (111b′) that surrounds the transverse hole (111c′) formed in the hemispherical portion (111′). Said transverse hole (111c') receives a central screw (113A) and insert (113b), which fit into the central hole (111c) drilled in the hemispherical part (111) to form a central axis of rotation (E1) and secure the parts (111)/(111′).

Each of the hemispherical parts (111)/(111′) features end appendages (111D)/(111D′) with ‘C’-shaped cross-sections that form cradles (BE) for mounting the ends of springs (ML) that make up the bars of the architectural/structural model system (MQ). Said end appendages (111D)/(111D′) feature holes (111e)/(111e′) in at least one of the parts, from which tubular projections (111f)/(111f′) extend for the assembly of an insert (113c) and a screw (113d) to secure the springs (ML).

The assembly between the hemispherical parts (111)/(111′) forms a sphere(ES) with an outer diameter (d1) corresponding to other parts of the educational model (MQ), allowing for the connection of other components and system configuration.

The adjustment of the angles (α) of the cradles (BE) and, consequently, the positioning of the springs (ML) is achieved by rotating the hemispherical parts (111)/(111′) relative to the central axis of rotation (E1) by loosening or tightening the screw (113A) (see FIGS. 2M to 2N).

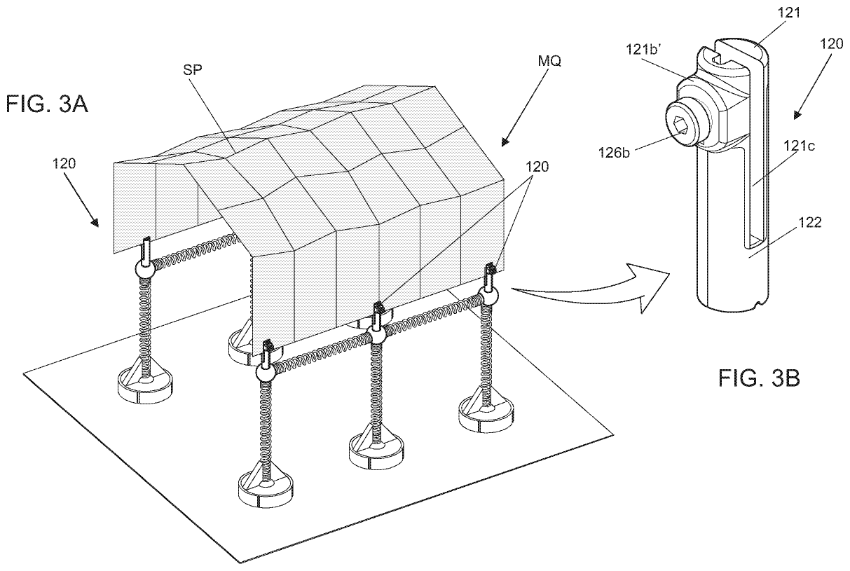

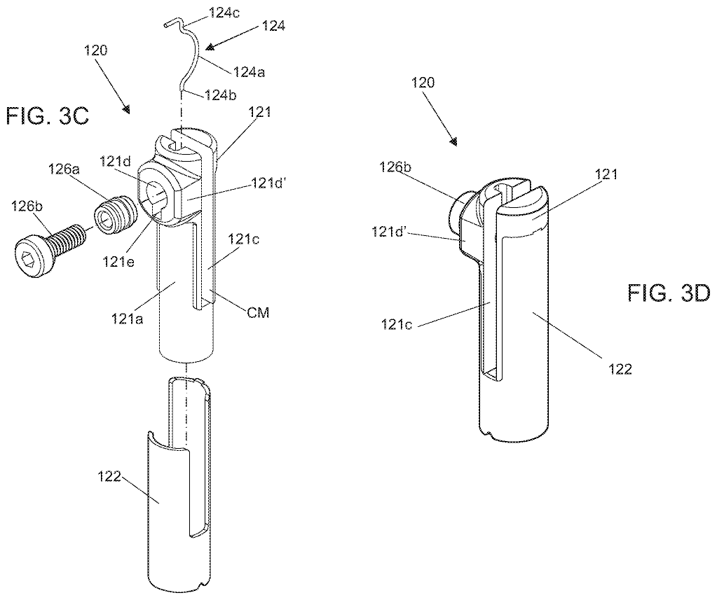

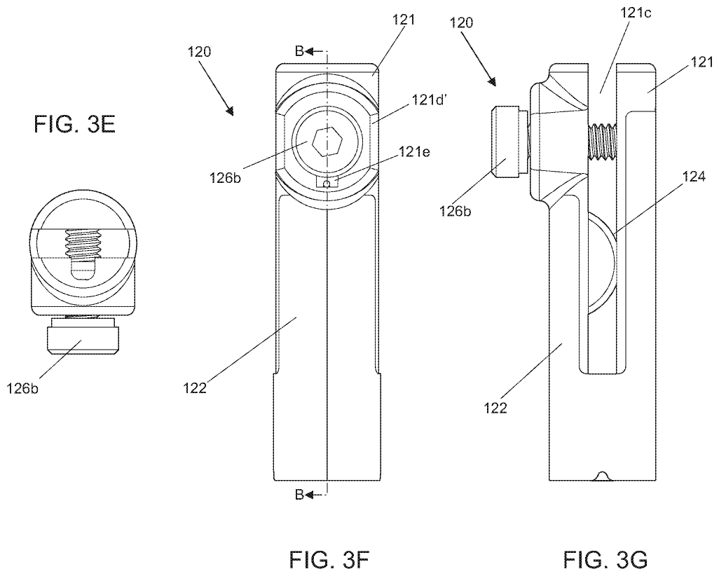

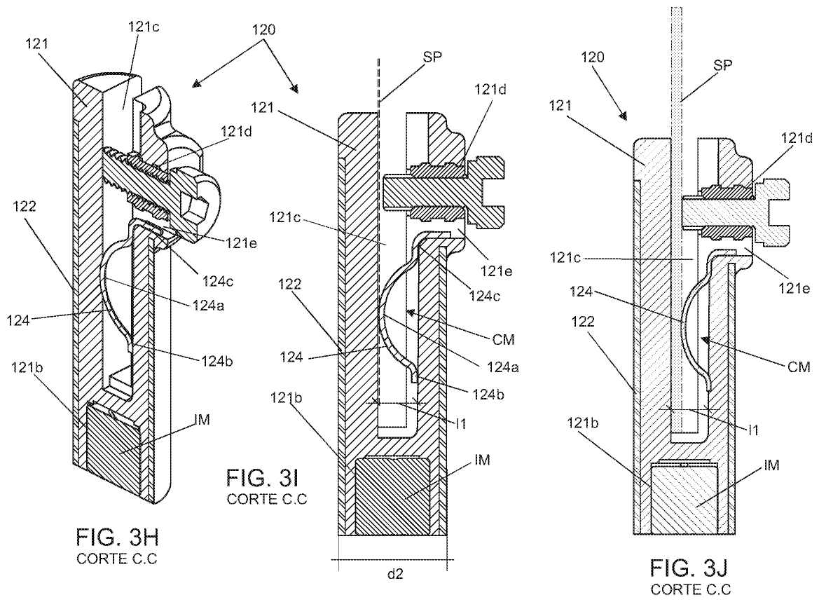

This connecting piece (120) (see FIGS. 3A to 3J) facilitates the connection of flat surfaces (SP) up to 1.5 mm thick, such as various types of paper, cardboard, transparencies, acrylic, EVA sheets, rubber, or any other material, as well as custom parts printed in 3D or modeled using any other process that have a flat section with a maximum thickness of 1.5 mm. Said connection piece (120) comprises a cylindrical element (121) made of polymer and provided with a surface recess (121a) that forms a step for receiving a tubular sleeve (122) made of carbon steel. The outer diameter (d2) of the connecting piece (120) has the same outer diameter as the springs (ML), allowing other connecting parts of the system to be connected to the connecting pieces (120).

The base of the cylindrical element (121) features a cavity (121b) for inserting the magnet (IM), while the body of the cylindrical element (121) includes, at its upper end, a central, longitudinal slit (121c) with a width (l1) corresponding to the thickness of the flat surface (SP), and in which a transverse hole (121d) is formed, equipped with a tubular projection (121d′) for receiving an insert (126a) and a screw (126b). Said transverse hole (121d) includes a U-shaped recess (121e) which, together with the central slot (121c), forms an inverted L-shaped chamber (CM) to receive the pre-tensioning spring (124) of the flat surface (SP) (see FIGS. 3H, 3I, and 3J).

Said spring (124) is made of stainless steel and comprises an arched segment (124a) provided with straight-line ends (124b) and (124c), the latter, in turn, having an inverted ‘L’-shaped extension that fits into the ‘U’-shaped recess (121e).

The preliminary securing performed by the spring (124) after the flat surface (SP) is inserted into the slot (121c) via the arched segment (124a) allows for positional adjustment so that the screw (126b) can subsequently be tightened and the flat surface (SP) permanently secured.

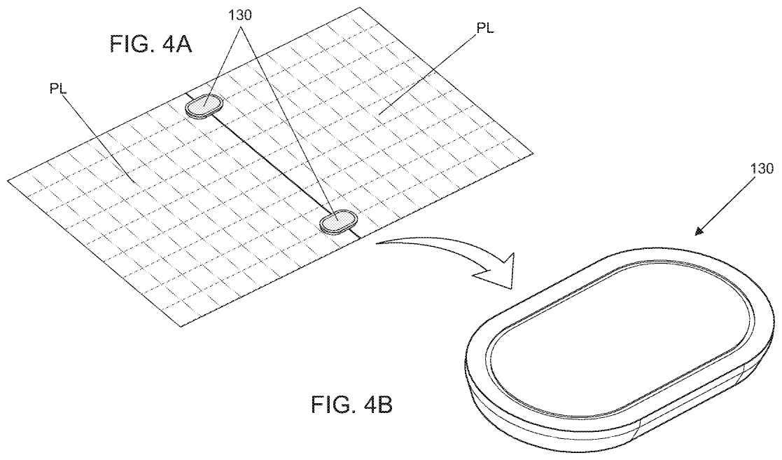

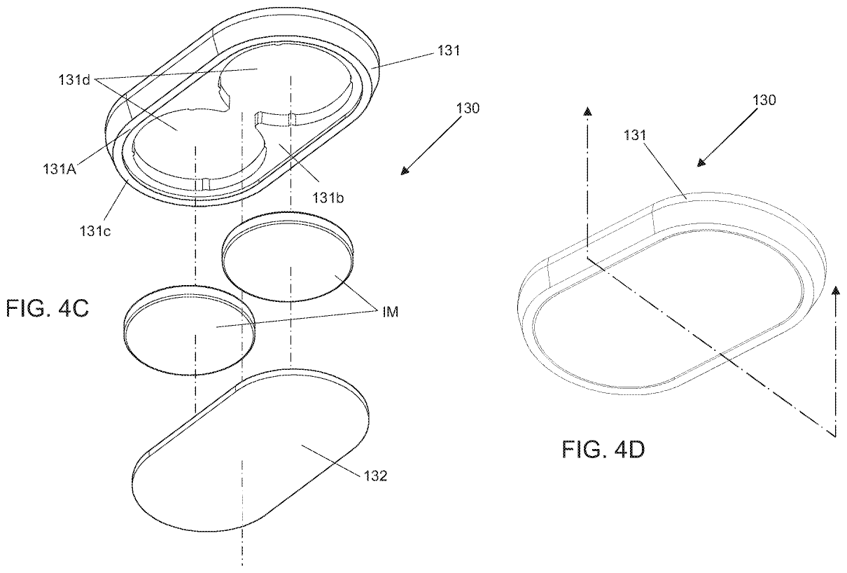

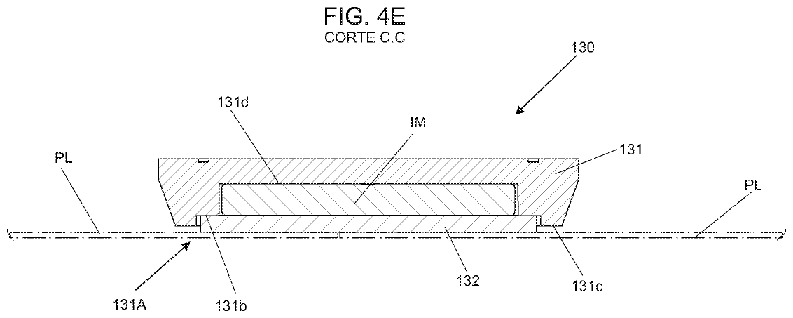

This base clip (130) (see FIGS. 4A through 4E) between two or more metal plates (PL) consists of an oblong plastic part (131) whose lower flat face (131A) features a stepped central portion (131b) forming a contouring edge (131c) and where a non-slip silicone pad (132) is accommodated. In the stepped area (131b), a pair of circular, equidistant recesses (131d) are formed to receive magnets (IM) that provide the con y connection between the steel base plates (PL) and, at the same time, with the anti-slip mat (132), maintaining their positions during the assembly and analysis of the structures.

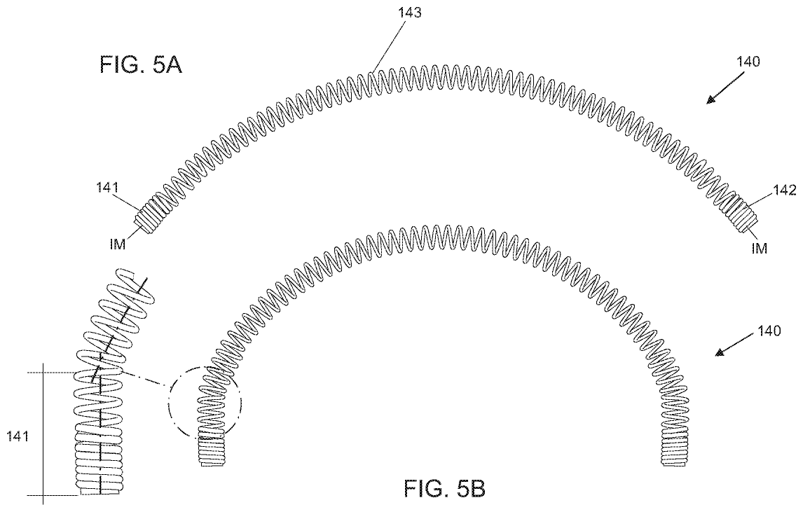

Finally, the curved spring (140) (see FIGS. 5A and 5B) consists of end straight sections (141)/(142) in which magnets (IM) are embedded, and for connection to other parts of the model (MQ) at these end straight sections (141)/(142), which are interspersed by a curved section (143) that, in turn, may vary in length and curvature depending on assembly requirements.

It is understood that when the present invention is put into practice, modifications may be made with respect to certain details of construction and form, without this implying a departure from the fundamental principles that are clearly set forth in the claims, it being understood that the terminology used is not intended to be limiting.

1. “SET OF STRUCTURAL CONNECTING PARTS FOR THE CONSTRUCTION OF ARCHITECTURAL/STRUCTURAL EDUCATIONAL MODELS,” a set of structural connecting parts (100) for the construction of architectural/structural educational models (MQ) as a teaching tool for structures; characterized in that the set of structural connecting parts (100) for forming architectural/structural educational models (MQ) comprises an adjustable connecting part (110) with springs (ML) fixed at a fixed angle (α) relative to each other, a connecting piece (120) comprising flat surfaces (SP) such as paper, cardboard, transparencies, acrylic, EVA sheets, rubber, or any other material; a base clip piece (130) between two or more metal plates (PL) and a curved spring (140); said parts (110), (120), (130), and (140) comprise distinct structural configurations of architectural/structural educational models (MQ).

2. “SET OF STRUCTURAL CONNECTION PARTS FOR ASSEMBLING ARCHITECTURAL/STRUCTURAL EDUCATIONAL MODELS,” according to claim 1, characterized by an adjustable connection part (110) comprising two hemispherical parts (111)/(111′) that are identical, corresponding, and made of polymer, provided with holes and recesses for material relief and covered by caps (112)/(112′) made of carbon steel sheet, wherein said cap (112′) is provided with a central hole (112b′) where radial recesses (112a′) are formed at the edge and which engage with radial teeth (111a′) provided at the edge of the central flange (111b′) surrounding the transverse hole (111c′) formed in the hemispherical part (111′); said transverse hole (111c′) receives a screw (113A) and an insert (113b) that fits into the central hole (111c) formed in the hemispherical part (111), forming a central axis of rotation (E1) and securing the parts (111)/(111′); each of the hemispherical parts (111)/(111′) has end appendages (111D)/(111D′) with cross-sections in the shape of a ‘C’ () that form cradles (BE) for springs (ML); said end appendages (111D)/(111D′) feature, in at least one of the parts, holes (111e)/(111e′) from which tubular projections (111f)/(111f′) for an insert (113c) and a screw (113d) extend.

3. “SET OF STRUCTURAL CONNECTING PARTS FOR ASSEMBLING ARCHITECTURAL/STRUCTURAL EDUCATIONAL MODELS”, according to claim 2, characterized by hemispherical parts (111)/(111′) forming a sphere(ES) with an outer diameter (d1) corresponding to other parts of the educational model (MQ).

4. “SET OF STRUCTURAL CONNECTING PARTS FOR ASSEMBLING ARCHITECTURAL/STRUCTURAL EDUCATIONAL MODELS”, according to claim 2, characterized by the rotation of the hemispherical parts (111)/(111′) relative to the central axis of rotation (E1), wherein loosening or tightening the screw (113A) adjusts the angles (α) of the cradles (BE) and the positioning of the springs (ML).

5. “SET OF STRUCTURAL CONNECTING PARTS FOR ASSEMBLING ARCHITECTURAL/STRUCTURAL EDUCATIONAL MODELS,” according to claim 1, characterized by a connecting part (120) configured to join flat surfaces (SP) up to 1.5 mm thick, such as different types of paper, cardboard, transparencies, acrylic, EVA sheets, rubber, or any other material, as well as custom parts printed in 3D or modeled using any other process that have a flat section with a maximum thickness of 1.5 mm.

6. “SET OF STRUCTURAL CONNECTION PARTS FOR THE ASSEMBLY OF ARCHITECTURAL/STRUCTURAL EDUCATIONAL MODELS,” according to claim 1, characterized in that the connection piece (120) comprises a cylindrical element (121) made of polymer and provided with a superficial recessed step (121a) for receiving a tubular sleeve (122) made of carbon steel; the outer diameter (d2) of the connecting piece (120) has the same outer diameter as the springs (ML); the base of the cylindrical element (121) has a cavity (121b) for inserting the magnet (IM), while the body of the cylindrical element (121) includes at its upper end a central, longitudinal slot (121c) with a width (l1) corresponding to the thickness of the flat surface (SP), and where a transverse hole (121d) is provided, featuring a tubular projection (121d') for receiving an insert (126a) and a screw (126b); said transverse hole (121d) includes a U-shaped recess (121e) which, together with the central slot (121c), forms an inverted L-shaped chamber (CM) for receiving the pre-tensioning spring (124) of the flat surface (SP); said spring (124) is made of stainless steel and comprises an arched segment (124a) provided with straight-line ends (124b) and (124c), the latter, in turn, having an inverted ‘L’-shaped extension accommodated in the ‘U’-shaped recess (121e).

7. “SET OF STRUCTURAL CONNECTING PARTS FOR THE ASSEMBLY OF ARCHITECTURAL/STRUCTURAL EDUCATIONAL MODELS,” according to claim 1, characterized by a base clip (130) between two or more metal plates (PL) consisting of an oblong plastic piece (131) whose lower flat face (131A) features a stepped central portion (131b) forming a contoured edge (131c) and where a non-slip silicone pad (132) is accommodated; in the stepped area (131b), a pair of circular and equidistant recesses (131d) are formed to receive magnets (IM) for connecting the steel base plates (PL).

8. “SET OF STRUCTURAL CONNECTION PARTS FOR ASSEMBLING ARCHITECTURAL/STRUCTURAL EDUCATIONAL MODELS,” according to claim 1, characterized by a curved spring (140) comprising end straight sections (141)/(142) in which magnets (IM) are embedded, which are interspersed by a curved section (143) that, in turn, may vary in length and curvature.
